(19) United States
(12) Patent Application Publication
(10) Pub. No.: US 2017/0012373 A1
(43) Pub. Date: Jan. 12, 2017

(54) CABLE WITH A CONNECTOR

(71) Applicant: Hitachi Metals, Ltd., Tokyo (JP)

(72) Inventor: Hideki NONEN, Mito (JP)

(21) Appl. No.: 15/194,805

(22) Filed: Jun. 28, 2016

(30) Foreign Application Priority Data
Jul. 8, 2015 (JP) 2015-136770

(51) Int. Cl. H01R 9/05; H01B 3/30; H01B 7/17; H01B 7/02; H01R 9/11; H01R 25/00

(52) U.S. Cl. CPC H01R 9/0524; H01R 9/11; H01R 25/003; H01B 7/17; H01B 7/0216; H01B 3/30

(57) ABSTRACT

A cable with a connector includes a cable for transmitting electric signals, a clamping member having electrical conductivity for clamping an end of the cable, and a connector accommodating the clamping member. The cable includes an insulated electric wire including a conductive wire covered with an insulator, a shielding member covering the insulated electric wire, a drain wire arranged with contacting the shielding member, and an outer coat covering an outer periphery of the shielding member. The clamping member clamps the cable from an outside of the outer coat. The drain wire folds back toward an outside of the outer coat at the end of the cable and is interposed between the clamping member and the outer coat.

The present application is based on Japanese patent application No. 2015-136770 filed on Jul. 8, 2015, the entire contents of which are incorporated herein by reference.

### BACKGROUND OF THE INVENTION

1. Field of the Invention

The invention relates to a cable with a connector, more particularly, to a cable with a connector in which the connector is provided at an end of the cable.

2. Description of the Related Art

Conventionally, a cable with a connector (a cable having a connector at its end) including an electrical conductive member surrounding the end of the cable and a shielding conductor electrically connected to the electrical conductive member in order to suppress noise from a wire of the cable and an adversary effect of external noise has been known (see e.g. JP-A-2010-15708).

JP-A-2010-15708 discloses a cable that includes a pair of insulated electric wires, each of which is composed of a conductor covered with an insulator, a braid as a shielding conductor covering the pair of insulated electric wires, and an electrically insulating sheath covering the braid. The braid is exposed from an end of the cable by removing the sheath by a predetermined length, and an exposed portion of the braid is folded back outside the sheath. Further, an electrically conductive circular clamping member clamps the folded portion of the braid from outside of the sheath. The clamping member is fixed to an electrically conductive connector shell.

### SUMMARY OF THE INVENTION

The cable disclosed by JP-A-2010-15708 needs a process of folding back the braid exposed from the end of the sheath to the outside of the sheath and of fitting the braid on an outer periphery of the sheath. Therefore, work burden of this process is heavy. Moreover, as the braid is interposed between the sheath and the clamping member along an entire periphery of the sheath, the sheath is slippery with the clamping member. As a result, this may cause “Shrink back” phenomenon which means that the sheath slips out from the clamping member due to thermal contraction arising from temperature drop or pulling tensile force applied to the cable. Accordingly, it is an object of the invention to provide a cable with a connector, which has excellent workability in assembling and can suppress the “Shrink Back”.

(1) According to one embodiment of the invention, a cable with a connector, comprises:

a cable for transmitting electric signals;

a clamping member having electrical conductivity for clamping an end of the cable; and

a connector accommodating the clamping member,

wherein the cable comprises:

an insulated electric wire comprising a conductive wire covered with an insulator;

a shielding member covering the insulated electric wire;

a drain wire arranged with contacting the shielding member; and

an outer coat covering an outer periphery of the shielding member,

wherein the clamping member clamps the cable from an outside of the outer coat,

wherein the drain wire folds back toward an outside of the outer coat at the end of the cable and is interposed between the clamping member and the outer coat.

(Effects of the invention)

According to the present invention, it is possible to provide a cable with a connector, which has excellent workability in assembling and can suppress the “Shrink Back”.

### BRIEF DESCRIPPTION OF THE DRAWINGS

Next, the present invention will be explained in more detail in conjunction with appended drawings, wherein:

FIG. 1 is a configuration diagram illustrating a breakout cable in a first embodiment according to the invention;

FIG. 2 is a perspective view of a second connector;

FIG. 3 is an exploded perspective view of the second connector;

FIG. 4 is a perspective view showing an end of a cable assembly accommodated in the second connector together with a connecting member;

FIG. 5A is a cross sectional view of the cable assembly taken along A-A line in FIG. 4;

FIG. 5B is a cross sectional view of the cable assembly taken along B-B line FIG. 5A;

FIG. 6 is a cross sectional view showing a clamping member within the second connector and its peripheral part;

FIG. 7 is a cross sectional view of a clamping member in a first connector 81, and one ends of four cables clamped by this clamping member;

FIG. 8 is a cross sectional view of a cable assembly in a comparative example; and

FIG. 9 is a cross sectional view of a cable assembly in a second embodiment according to the invention.

### DETAILED DESCRIPTION OF THE PREFERED EMBODIMENTS

### First Embodiment

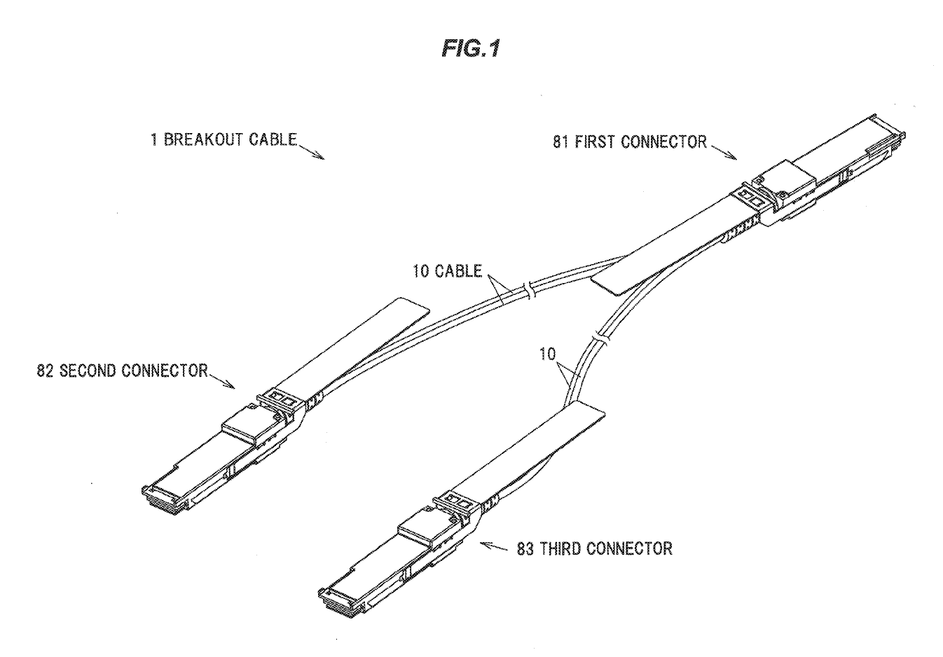

Next, a cable with a connector in a first embodiment according to the invention will be described below with reference to FIGS. 1 to 7. Furthermore, the embodiments described below are only intend to show preferred examples for enforcing the present invention, even though various technical matters that are technically preferable are shown specifically, a technical scope of the present invention is not limited by the specific embodiments.

(Total configuration of a breakout cable)

FIG. 1 is a configuration diagram illustrating a breakout cable as a cable with a connector in the first embodiment according to the invention.

A breakout cable 1 includes a first connector 81, a second connector 82, a third connector 83, and cables 10 to link between the first connector 81 and the second connector 82, and between the first connector 81 and the third connector 83, respectively. The breakout cable 1 is configured such that four cables 10 derived from the first connector 81 are divided into two pairs of two cables and connected to the second connector 82 and the third connector 83, respectively. Each pair of the two cables 10 are connected to each of the second connector 82 and the third connector 83.

The first to third connectors 81 to 83 are connected to different information processing devices, respectively. The information processing devices communicate each other by transmitting electrical signals through the cables 10. The first to third connectors 81 to 83 are plugin connectors pursuant to QSFP (Quad Small Formfactor Pluggable) standard and are plugged in a cage (not shown) fixed on a board of each of the information processing device.

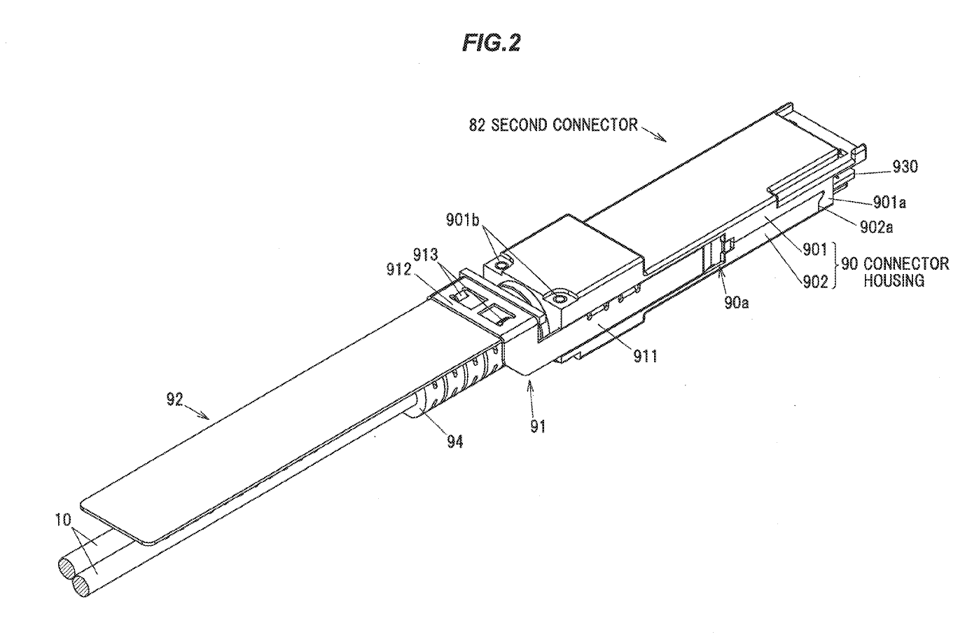

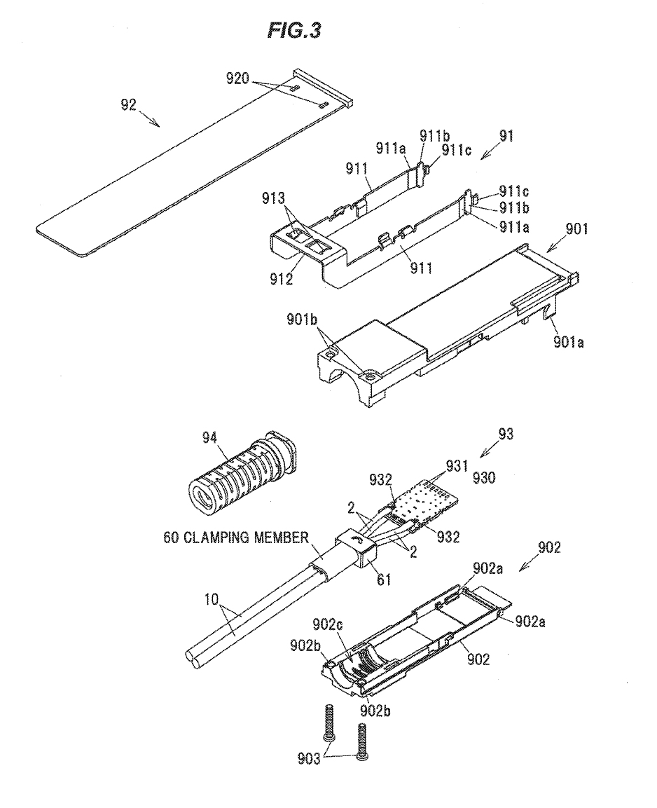

FIG. 2 is a perspective view of the second connector 82. FIG. 3 is an exploded perspective view of the second connector 82. The third connector 83 is configured likewise the second connector 82. Otherwise, the first connector 81 is configured likewise the second and third connectors 82, 83 except the number of the cables 10 to be connected to the first connector 81. However, the present invention is not limited thereto, and the configurations of the first to third connectors 81 to 83 may be different from each other.

The second connector 82 includes a connector housing 90 made of a metal having electrical conductivity, a sliding member 91 which is held slidably with the connector housing 90, a pull member 92 coupled to the sliding member 91, a connecting member 93 accommodated in the connector housing 90, and a boot 94 made of a cylindrical elastic member such as rubber, for passing the cables 10 therethrough.

The connector housing 90 has a rectangular parallelepiped-shape and a direction for insertion into and detachment from the cage is a longitudinal direction of the connector housing 90. The connector housing 90 includes a first housing member 901 and a second housing member 902. The first hosing member 901 and the second housing member 902 are formed by casting e.g. zinc alloy.

The first housing member 901 includes locking projections 901a at one end in the longitudinal direction of the first housing member 901, and screw holes 901b at the other end in the longitudinal direction of the first housing member 901, into which bolts 903 are screwed. The second housing member 902 includes engaging concave portions 902a at one end in the longitudinal direction of the second housing member 902, and bolt insertion holes 902b at the other end in the longitudinal direction of the second housing member 902, through which bolts 903 pass.

The first housing member 901 and the second housing member 902 are linked to each other by engaging the locking projections 901a with the engaging concave portions 902a at the one end in the longitudinal direction of the first and second housing members 901, 902, and by screwing the bolts 903 passed through the bolt insertion holes 902b into the screw holes 901b at the other end in the longitudinal direction of the first and second housing members 901, 902. Also, a recessed portion 90a extending in parallel with the longitudinal direction is formed on each side surface of the connector housing 90a. It is possible to prevent the connector housing 90 from unexpected slipping out from the cage by fitting a locking piece formed on the cage into the recessed portion 90a.

The connector housing 90 accommodates a clamping member 60 having electrical conductivity for clamping the other ends of the cables 10, and a resin member 61 for fixing Twinax cables (twinaxial cables) 2 in each of the cables 10. The clamping member 60 is sandwiched between the first housing member 901 and the second housing member 902. The clamping member 60 conducts electrically with the first housing member 901 and the second housing member 902. In the present embodiment, the clamping member 60 which is made of a cylindrical metallic member clamps the cables 10. Below, the cables 10 clamped by the clamping member 60 at the ends and the clamping member 60 are collectively called as “a cable assembly”.

The sliding member 91 comprises a pair of arms 911 extending in parallel with each other, a trunk 912 formed between the pair of arms 911, and a pair of salients 913 to be linked with the pull member 92, as one piece. The pull member 92 has linking holes 920 at one end. The sliding member 91 and the pull member 92 are linked each other by engaging the salients 913 into the linking holes 920.

As the pull member 92 is pulled toward a direction departing away from the connector housing 90, the sliding member 91 slides along the recessed portion 90a formed on the side surface of the connector housing 90. The sliding member 91 includes a slope section 911a, a planar plate section 911b, and a curved section 911c at one end of each arm 911. As the sliding member 91 slides, the locking piece of the cage abuts the curved section 911c then is pushed out from the recessed portion 90a, so that a locking state of the connector housing 90 by the locking piece is released. Consequently, the connector housing 90 can be detached from the cage.

The connecting member 93 comprises a plurality of connecting terminals 931 and a plurality of electrodes 932 on a board 930 made of an insulator such as glass epoxy. The board 930 is held by the connector housing 90. Electronic components (not shown) such as capacitor, resistor are mounted on the board 930. The plurality of connecting terminals 931 are provided linearly at one end of the board 930 exposed from the connector housing 90. The plurality of electrodes 932 are provided on the other end (i.e. an end opposite to the end where the plurality of connecting terminals 931 are provided) of the board 930, and connected to tip portions of a pair of signal wire conductors in the cable 10 to be described later.

(Configuration of the cable assembly)

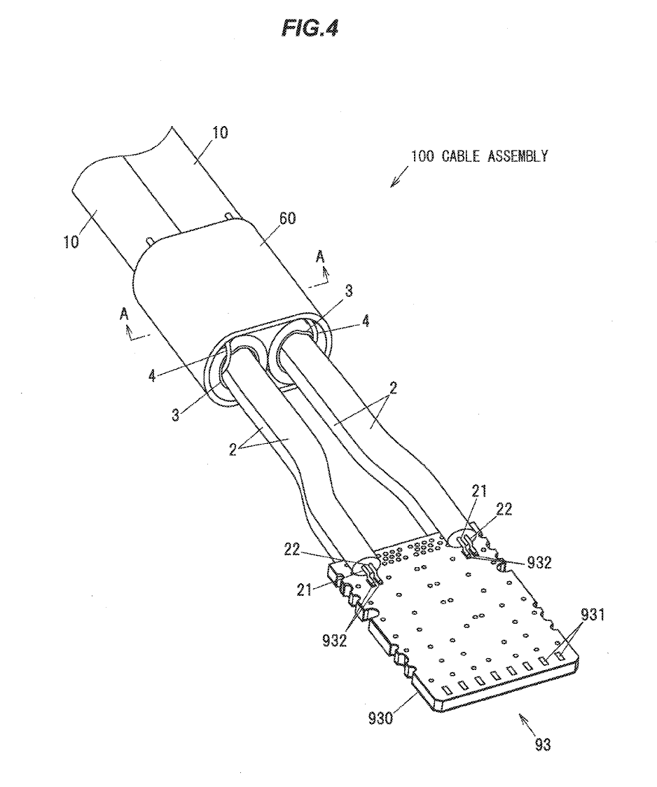

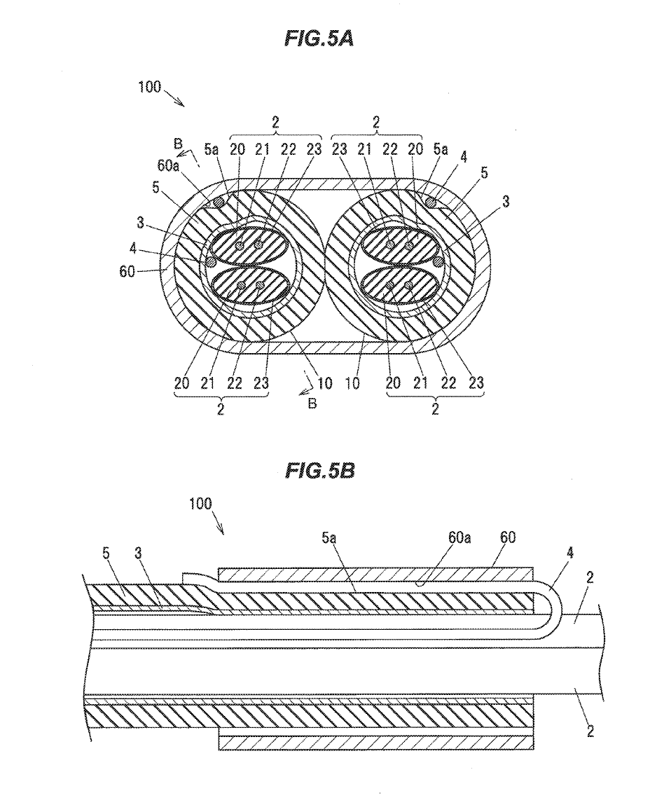

FIG. 4 is a perspective view of the other end of a cable assembly 100 accommodated in the second connector 82 together with the connecting member 93. FIG. 5A is a cross sectional view of the cable assembly 100 taken along A-A line in FIG. 4. FIG. 5B is a cross sectional view of the cable assembly 100 taken along B-B line in FIG. 5A. Furthermore, the resin member 61 is not shown in FIG. 4.

The cable 10 includes twinaxial cables 2 for transmitting differential signals, a shielding member 3 collectively covering the twinaxial cables 2, a drain wire 4 arranged to contact the shielding member 3, and a jacket 5 as an outer coat which covers an outer periphery of the shielding member 3. The twinaxial cable 2 is one example of the insulated electric wire made of a signal wire conductor covered with an insulator.

FIG. 5B shows a cross sectional view of the clamping member 60, the jacket 5, and the shielding member 3 taken along B-B line in FIG. 5A and a side view of the pair of twinaxial cables 2 and the drain wire 4 within the shielding member 3.

In the present embodiment, the twinaxial cable 2 comprises a pair of signal wire conductors 21, 22 arranged in parallel with each other and covered collectively by an insulator 20 which is covered by a shielding tape 23. The pair of signal wire conductors 21, 22 are made of conductive wires comprising high conductive metal such as copper, aluminum. The insulator 20 is made of low-k (low dielectric constant) resin e.g. polyethylene resin, fluorocarbon resin, foamed polyethylene resin, foamed fluorocarbon resin. The shielding tape 23 is formed by bonding a conductive layer made of metal such as copper to a sheet-like substrate made of e.g. polyester resin.

Also, in the present embodiment, the shielding member 3 covers two twinaxial cables 2 collectively. As the shielding member 3, a braid wire formed by interknitting strands made of e.g. stainless steel into a tubular shape may be used. Moreover, an electrically conductive tape including an electrically conductive adhesive layer on one surface of a strip-shaped flexible metallic conductor may be used as the shielding member 3. In this case, the electrical conductive tape is spirally wound around the two twinaxial cables 2 with the adhesive layer inside. The adhesive layer contacts the drain wire 4.

The drain wire 4 is made of e.g. a single copper wire having a circular cross section. A surface of the drain wire 4 may be Sn-plated or Ag-plated. In the present embodiment, a single drain wire 4 is arranged inside the shielding member 3, but the present invention is not limited thereto. A plurality of drain wires 4 may be arranged inside the shielding member 3. The drain wire 4 is electrically grounded with contacting the shielding member 3.

The jacket 5 is a tubular insulator made of resin material. More specifically, as the resin material, fluoro resins such as polytetrafluoroethylene (PTFE), tetrafluoroethylene-perfluoroalkylvinylether copolymer (PFA), tetrafluoroethylene-hexafluoropropylene (FEP) may be used from the point of view of friction resistance, low-frictional properties, low-temperature resistance, and heat-resistance, and the like.

The clamping member 60 clamps the cables 10 with reducing a diameter of a cylindrical metal member made of copper. In the present embodiment, the clamping member 60 clamps the ends of the cables 10 collectively. Specifically, the clamping member 60 of each of the second connector 82 and the third connector 83 clamps the ends of two cables 10 collectively, and the clamping member 60 of the first connector 81 (described later) clamps the ends of four cables 10 collectively.

The clamping member 60 clamps the cables 10 from the outside of the jacket 5. Also, the drain wire 4 folds back toward an outside of the jacket 5, i.e. outwardly from the jacket 5, at the end of the cable 10 as shown in FIG. 5B. The drain wire 4 is interposed between the clamping member 60 and the jacket 5. The jacket 5 is pressed inwardly by a pressing force of the clamping member 60. An outer periphery surface 5a of the jacket 5 is recessed inwardly at a part abutting the drain wire 4. The drain wire 4 is pressed to contact an inner periphery surface 60a of the clamping member 60 by a restoring force of the jacket 5 and conducts electrically with the clamping member 60.

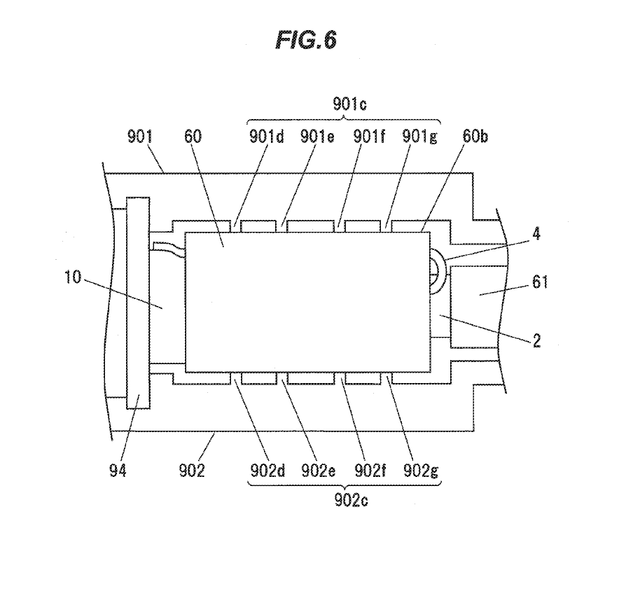

FIG. 6 is a cross sectional view of the clamping member 60 and its peripheral part inside the second connector 82. The clamping member 60 is sandwiched and held between a first holding section 901c formed on the first housing member 901 and a second holding section 902c formed on the second housing member 902.

First to fourth protrusions 901d to 901g are provided at the first holding member 901c, and first to fourth protrusions 902d to 902g are provided at the second holding member 902c similarly. The first housing member 901 and the clamping member 60 conducts electrically with each other since tip portions of the first to fourth protrusions 901d to 901g of the first holding section 901c contact to the outer periphery surface 60b of the clamping member 60. Also, the second housing member 902 and the clamping member 60 conducts electrically with each other since tip portions of the first to fourth protrusions 902d to 902g of the second holding section 902c contact to the outer periphery surface 60b of the clamping member 60.

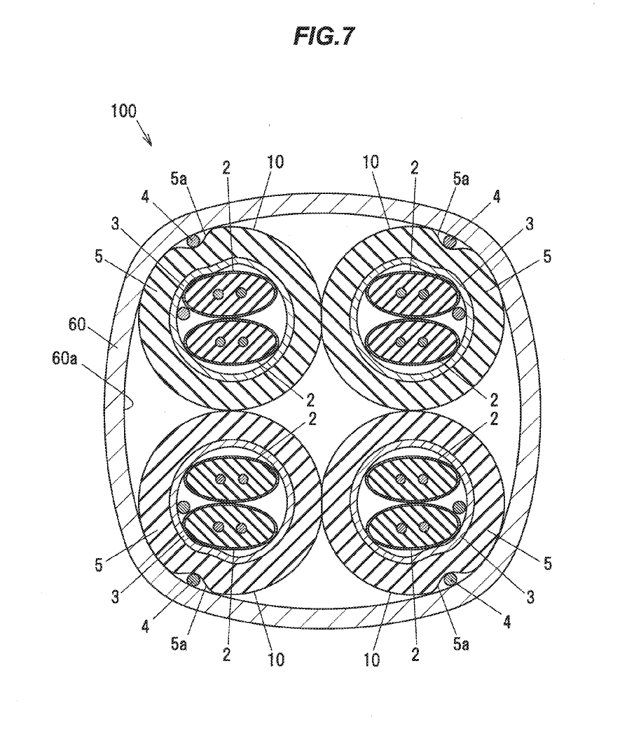

FIG. 7 is a cross sectional view of the clamping member 60 in the first connector 81 and one ends of four cables 10 clamped by the clamping member 60. Each drain wire 4 in each of the four cables 10 is interposed between the clamping member 60 and the jacket 5. The other ends of two of the four cables 10 are accommodated in the second connector 82 and the other ends of two other cables 10 are accommodated in the third connector 83.

### Comparative Example

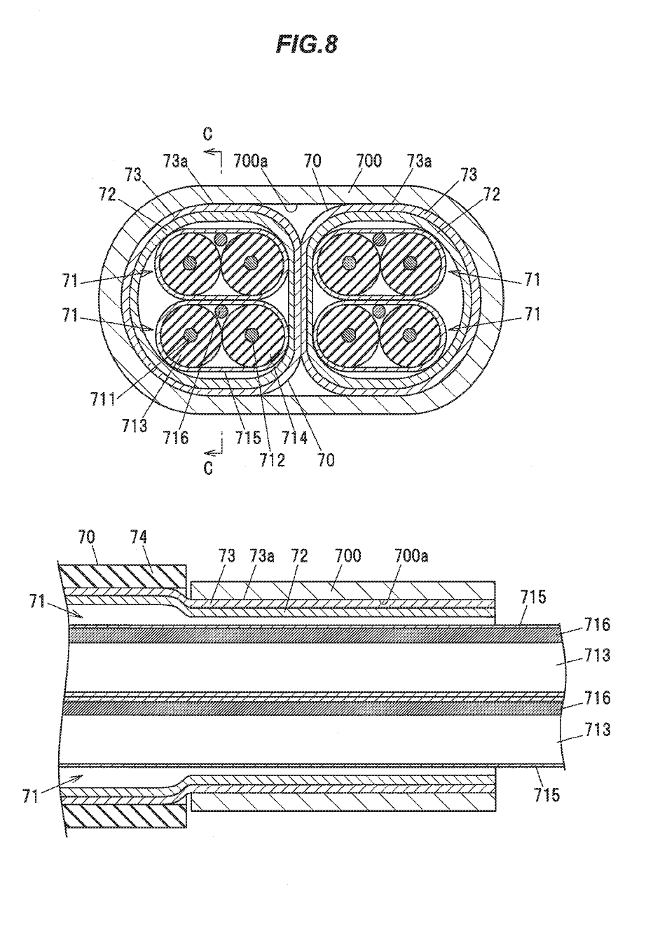

FIG. 8 is a cross sectional view of a cable assembly 7 in a comparative example. The cable assembly 7 includes two cables 70 and a clamping member 700 to clamp the two cables 70 collectively. The cable 70 includes a pair of twinaxial cables 71, first and second shielding conductors 72, 73 covering the pair of twinaxial cables 71, and a jacket 74. The first shielding conductor 72 is made of an electrically conductive tape. The second shielding conductor 73 is made of a braid wire and over the outer periphery of the first shielding conductor 72.

The twinaxial cable 71 includes a first signal wire conductor 711, a second signal wire conductor 712, a first insulator 713 covering the first signal wire conductor 711, and a second insulator 714 covering the second signal wire conductor 712. A shielding tape 715 covers the first and second insulators 713, 714 collectively. A drain wire 716 is interposed between the first insulator 713 and the second insulator 714 within the shielding tape 715.

A part of the jacket 74 where the clamping member 700 clamps is removed from the cable 70. An outer periphery surface 73a of the second shielding conductor 73 is exposed to the outside from the jacket 74. An inner periphery surface 700a of the clamping member 700 contacts the outer periphery surface 73a of the second shielding conductor 73. The clamping member 700 clamps the second shielding conductor 73, the first shielding conductor 72, and the pair of twinaxial cables 71 inwardly.

In the cable assembly 7 in the comparative example, the jacket 74 is not clamped by the clamping member 700. Therefore, due to the thermal contraction arising from temperature drop or the pulling tensile force affecting the cable 70, the so-called “Shrink Back” phenomenon, i.e. an end surface 74a of the jacket 74 is departed away from the clamping member 700 so that the second shielding conductor 73 is exposed widely, tends to arise. The “Shrink Back” lessens the bending resistance property of the cable 70, thereby causing the deterioration in mechanical strength of the cable 70.

Meanwhile, the cable assembly 100 in the first embodiment according to the present invention, the jacket 5 is clamped by the clamping member 60 so that the “Shrink Back” can be suppressed.

### Functions and Advantageous Effects of the First Embodiment

The first embodiment as described above has the following functions and advantageous effects.

(1) As the clamping member 60 clamps the ends of the cables 10 from the outside of the jacket 5, the clamping force of the clamping member 60 is applied on the jacket 5, thereby suppressing the “Shrink Back”, i.e. the jacket 5 moves toward the direction to escape from the clamping member 60. Specially, in the present embodiment, as the outer periphery surface 5a of the jacket 5 contacts directly the inner periphery surface 60a of the clamping member 60, a friction force acting between the outer periphery surface 5a of the jacket 5 and the inner periphery surface 60a of the clamping member 60 suppresses securely the “Shrink Back” of the jacket 5.

(2) As the drain wire 4 folds back outwardly from the jacket 5 and the drain wire 4 is interposed between the clamping member 60 and the jacket 5, the drain wire 4 contacts certainly with the clamping member 60. In addition, as a process of folding back the drain wire 4 outwardly from the jacket 5 in the first embodiment is easier than the process of folding back the shielding member 3 outwardly from the jacket 5 in the comparative example, so that the workability in the process of assembling the cable assembly 100 improves.

(3) As the clamping member 60 clamps the ends of the cables 10 collectively, comparing with clamping the ends of the cables 10 respectively, for example, the workability can improve and the number of components can be reduced. Moreover, the increase in size of the connector housing 90 can be suppressed.

(4) As the clamping member 60 is made of the cylindrical metallic material and fixed to the cables 10 by clamping, the cable assembly 100 can be assembled easily and a sufficient clamping force can be applied to the jacket 5.

### Second Embodiment

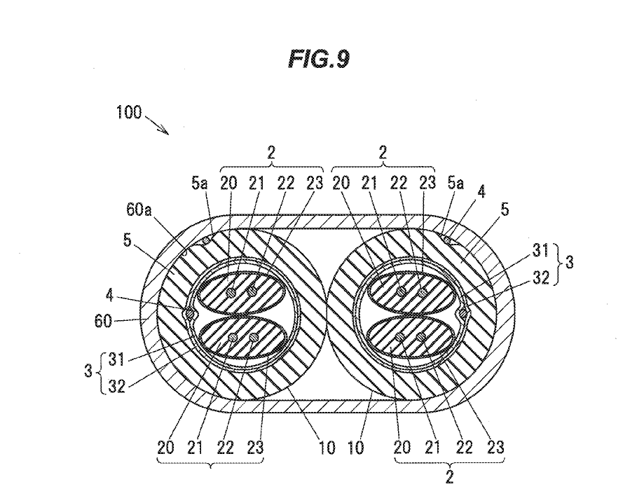

Next, a second embodiment according to the present invention will be described below with reference to FIG. 9. In connection with the first embodiment, the case that the drain wire 4 is arranged inside the shielding member 3 is described. In the second embodiment, the shielding member 3 in the cable 10 has a two-layer structure including an inner layer and an outer layer. Below, the description is focused on this difference.

FIG. 9 is a cross sectional view of a cable assembly 100 in the second embodiment. The same reference numerals are assigned to the elements having substantially the same functions as the elements in the first embodiment and the redundant description thereof is omitted.

In the present embodiment, the cable 10 includes a first shielding conductor 31 as the inner layer to cover a pair of twinaxial cables 2 and a second shielding conductor 32 as the outer layer to cover an outer periphery of the first shielding conductor 31. The drain wire 4 is interposed between the first shielding conductor 31 and the second shielding conductor 32.

The first shielding conductor 31, the second shielding conductor 32, and the drain wire 4 contact and conduct electrically each other. The electrically conductive tape may be used as the first and second shielding conductors 31, 32. Also the braid wire may be used as either or both of the first shielding conductor 31 and the second shielding conductor 32.

The drain wire 4, likewise the first embodiment, folds back outwardly from the jacket 5 at the ends of the cables 10. The drain wire 4 is interposed between the clamping member 60 and the jacket 5. The jacket 5 is pressed inwardly by the clamping force of the clamping member 60. The drain wire 4 is pressed to contact an inner periphery surface 60a of the clamping member 60 by a restoring force of the jacket 5 and conducts electrically with the clamping member 60.

Also, in the second embodiment, the functions and advantageous effects similar to those in the first embodiment can be achieved. Moreover, in the second embodiment, the shielding member 3 has the two-layer structure including the inner layer and the outer layer, and the drain wire 4 is interposed between the first shielding conductor 31 as the inner layer and the second shielding conductor 32 as the outer layer, the shielding effect is enhanced and the contact the drain wire 4 and the shielding member 3 can be further secured.

### Summary of the Embodiments

Next, technical ideas understood from the embodiments as described above will be described below with using the reference numerals, etc., used in the description of the embodiments. However, each reference numeral, etc., described below is not intended to limit the constituent elements in the claims to the members, etc., specifically described in the embodiments.

[1] A cable with a connector (a breakout cable 1), comprising:

a cable (10) for transmitting electric signals;

a clamping member (60) having electrical conductivity for clamping an end of the cable (10); and

a connector (81 to 83) accommodating the clamping member (60),

wherein the cable (10) comprises:

an insulated electric wire (twinaxial cable 2) comprising a conductive wire (signal wire conductors 21, 22) covered with an insulator (20);

a shielding member (3) covering the insulated electric wire (2);

a drain wire (4) arranged with contacting the shielding member (3); and

an outer coat (a jacket 5) covering an outer periphery of the shielding member (3),

wherein the clamping member (60) clamps the cable (10) from an outside of the outer coat (5),

wherein the drain wire (4) folds back toward an outside of the outer coat (5) at the end of the cable (10) and is interposed between the clamping member (60) and the outer coat (⁵).

[2] The cable with the connector (1) according to [1], wherein the cable (10) comprises a plurality of cables and the clamping member (60) clamps ends of the plurality of cables (10) collectively.

[3] The cable with the connector (1) according to [1] or [2], wherein the clamping member (60) comprises a cylindrical metallic material and clamps the cable (10).

[4] The cable with the connector (1) according to anyone of [1] to [3], wherein the shielding member (3) comprises a first shielding conductor (31) covering the insulated electric wire (2), and a second shielding conductor (32) covering an outer periphery of the first shielding conductor (31),

wherein the drain wire (4) is interposed between the first shielding conductor (31) and the second shielding conductor (32).

[5] The cable with the connector (1) according to anyone of [1] to [4], wherein the cable (10) comprises a plurality of insulated electric wires (2) covered with the shielding member (3) collectively, wherein each of the insulated electric wires (2) comprises a twinaxial cable (2) comprising a pair of signal wire conductors (21, 22) arranged in parallel with each other and covered with an insulator.

(Appendix)

Although the embodiments of the invention have been described, the invention is not to be limited to the embodiments. Further, it should be noted that all combinations of the features described in the embodiments are not necessary to solve the problem of the invention.

Also, the various kinds of modifications can be implemented without departing from the gist of the invention. For example, in the first and second embodiments, the case where the cable 10 includes a plurality of twinaxial cables 2 is described. However, only a single twinaxial cable 2 may be provided inside the shielding member 3. Also, the present invention is not limited to the twinaxial cables 2. Other kinds of insulated electric wires made of a conductor covered with an insulator may be appropriately used. In this case, the conductor wire is not limited to the signal wire conductor for transmitting signals, and power supply wire for supplying electric power may be used.

Also, in the embodiments described above, the case where the cables 10 are connected to a single connector (each of the first, second, and third connectors) is described. However, the present invention is not limited to the embodiments, and a single cable 10 may be connected to one of the connectors. Moreover, the configuration of the connector is not limited to the embodiments described above. For example, a connector housing may comprise a case made of resin which accommodates a shield shell made of electrically conductive metal. For this case, the clamping member 6 is electrically connected to the shield shell.

Still further, in the embodiments described above, the case where the clamping member 60 is made of a cylindrical metallic material is described. However, the present invention is not limited thereto and the clamping member 60 may be made of an electrically conductive tape.

What is claimed is:

1. A cable with a connector, comprising:
a cable for transmitting electric signals;
a clamping member having electrical conductivity for clamping an end of the cable; and
a connector accommodating the clamping member,
wherein the cable comprises:
an insulated electric wire comprising a conductive wire covered with an insulator;
a shielding member covering the insulated electric wire;
a drain wire arranged with contacting the shielding member; and
an outer coat covering an outer periphery of the shielding member,
wherein the clamping member clamps the cable from an outside of the outer coat,
wherein the drain wire folds back toward an outside of the outer coat at the end of the cable and is interposed between the clamping member and the outer coat.

2. The cable with the connector according to claim 1, wherein the cable comprises a plurality of cables and the clamping member clamps ends of the plurality of cables collectively.

3. The cable with the connector according to claim 1, wherein the clamping member comprises a cylindrical metallic material and clamps the cable.

4. The cable with the connector according to claim 1, wherein the shielding member comprises a first shielding conductor covering the insulated electric wire, and a second shielding conductor covering an outer periphery of the first shielding conductor,
wherein the drain wire is interposed between the first shielding conductor and the second shielding conductor.

5. The cable with the connector according to claim 1, wherein the cable comprises a plurality of insulated electric wires covered with the shielding member collectively, wherein each of the insulated electric wires comprises a twinaxial cable comprising a pair of signal wire conductors arranged in parallel with each other and covered with an insulator.
